(19) United States
(12) Patent Application Publication
(10) Pub. No.: US 2018/0357610 A1
(43) Pub. Date: Dec. 13, 2018

(54) METHOD AND SYSTEM FOR COLLABORATIVE SCHEDULING OF PRODUCTION AND TRANSPORTATION BASED ON SHUFFLED FROG LEAPING AND PATH RELINKING ALGORITHMS

(71) Applicant: Hefei University of Technology, Hefei (CN)

(72) Inventors: Xinbao LIU, Hefei (CN); Jun PEI, Hefei (CN); Min KONG, Hefei (CN); Zhanhui WEI, Hefei (CN); Shaojun LU, Hefei (CN); Qingru SONG, Hefei (CN); Xiaofei QIAN, Hefei (CN)

(21) Appl. No.: 16/006,694

(22) Filed: Jun. 12, 2018

(30) Foreign Application Priority Data
Jun. 12, 2017 (CN) 201710439141.7

(51) Int. Cl. G06Q 10/10; G06Q 10/08

(52) U.S. Cl. CPC G06Q 10/1093; G06F 7/58; G06Q 10/083

(57) ABSTRACT

A method and system for collaborative scheduling of production and transportation based on shuffled frog leaping and path relinking algorithms. The method includes the following steps: 1. setting algorithm parameters; 2. generating an initial population; 3. calculating fitness values; 4. grouping the population; 5. performing local search on all groups and updating individuals in groups; 6. performing global search on all groups and updating individuals in groups; 7. gathering all groups to obtain a new population; 8. performing a greedy path relinking algorithm on elegant solutions in the population to obtain an updated population; and, 9. determining termination conditions of algorithms; if so, ending; or otherwise, returning to the step 3.

### TECHNICAL FIELD

The present disclosure relates to the technical field of supply chains, and in particular to a method and system for collaborative scheduling of production and transportation based on shuffled frog leaping and path relinking algorithms.

### BACKGROUND OF THE PRESENT INVENTION

In the 21^{st} century, the competition among enterprises has already extended to the supply chains. Also, the core competitiveness of manufacturing enterprises is not only the manufacturing capacity, but the collaborative capacity of supply chains. Enterprises need to arrange the production more appropriately by integrating transportation and delivery information between upstream suppliers and downstream clients, thus reducing the production cycle and saving resources to cope with the increasingly fierce competition. An enterprise operates as a huge network which is perceptible and configurable by the application of the IoT technology, so that the real-time tracking of materials by the enterprise is realized and the collaborative control of production and transportation in supply chains is enhanced. Further, production systems and logistics transportation systems can be jointly optimized to increase the overall economic benefit of the enterprise, and thus the service level of the enterprise is enhanced.

At present, studies on the collaborative scheduling focus on the traditional production mode where a machine can process only one job every time. However, in the actual production process, there is a case where a machine needs to process a batch of jobs with different sizes simultaneously. The scheduling problem under this case is more complex, which is called the batch scheduling. Moreover, in the traditional scheduling, the transportation time is often abstracted as the same in the case of considering distributed suppliers and distributed clients, which cannot fit the production requirements in the collaborative scheduling environment.

### SUMMARY OF THE PRESENT INVENTION

An objective of the present disclosure is to improve the rationality of collaborative scheduling of production and transportation, so that the production cost can be reduced and the working efficiency can be improved.

In an aspect, the present disclosure provides a method for collaborative scheduling of production and transportation based on shuffled frog leaping and path relinking algorithms, including:

step 1: by using the processing time for jobs and the time for transportation between each machine and clients as inputs, initializing parameters in shuffled frog leaping and path relinking algorithms, including the total number of individuals in a population N, the number of groups divided from the population S, the number of iterations L and the maximum number of iterations Lₘₐₓ, where 1≤L≤Lₘₐₓ; and initializing L=1;

step 2: generating an initial population P={P₁^{(L)}, . . . , Pᵢ^{(L)}, . . . , P_{N}^{(L)}} according to the inputs and obtaining an initial position Pᵢ^{(L)}={Pₙ^{(L)}, P₁₂^{(L)}, . . . , P_{id}^{(L)}, . . . , Pᵢ₍ₙ₊ₘ₋₁₎^{(L)}} of the i^{th} individual in the L^{th} generation based on the initial population, where Pᵢ^{(L)} is an array of integers between 1 and n+m−1, P_{id}^{(L)} represents a position of the i^{th} individual in the L^{th} generation in a search space with the d^{th} dimension for indicating a corresponding job, where 1≤d≤n+m−1 and 1≤i≤N; wherein n represents the number of jobs, and m represents the number of machines;

step 3: calculating fitness values F(L)={F₁^{(L)}, . . . , Fᵢ^{(L)}, . . . , F_{N}^{(L)}} for N individuals in the L^{th} generation, where 1≤i≤N and Fᵢ^{(L)} represents a fitness value for the i^{th} individual in the L^{th} generation;

step 4: dividing N individuals in the L^{th} generation into S groups, with a set of S groups denoted by MEX(L)={MEX₁^{(L)}, MEX₂^{(L)}, . . . MEXₖ^{(L)}, . . . MEXₛ^{(L)}}, where MEXₖ^{(L)}={Sₖ₁^{(L)}, . . . , Sₖₕ^{(L)}, . . . , S_{k(N/S)}^{(L)}} represents the k^{th} group in all groups in the L^{th} generation, where 1≤k≤S and 1≤h≤N/S; and setting k=1, wherein sₖₕ^{(L)} represents the h^{th} individual in the k^{th} group;

step 5: performing a local search operator on the h^{th} individual sₖₕ^{(L)} in the group MEXₖ^{(L)} and updating the group MEXₖ^{(L)};

step 6: repeating the step 5 until the local search operator is performed on all individuals in the group MEXₖ^{(L)};

step 7: randomly selecting two individuals from the group MEXₖ^{(L)} to perform a global search operator and updating the group MEXₖ^{(L)};

step 8; assigning k+1 to k and determining whether k≤S is satisfied currently; if so, performing the step 6; or otherwise, performing the step 9;

step 9: gathering groups updated in the step 7 to obtain an updated population P;

step 10: randomly selecting two individuals from P to perform a greedy path relinking operator and updating P; and

step 11: assigning L+1 to L and determining whether L≤Lₘₐₓ is satisfied currently; if so, performing the step 3; or otherwise, representing the completion of Lₘₐₓ iterations; and outputting the iteration result as a scheme of assigning jobs to each machine and a scheduling result of processing sequences on each machine.

In another aspect, the embodiments of the present disclosure provide a system for collaborative scheduling of production and transportation based on shuffled frog leaping and path relinking algorithms, including:

a calculation module for performing:

step 1: by using the processing time for jobs and the time for transportation between each machine and clients as inputs, initializing parameters in shuffled frog leaping and path relinking algorithms, including the total number of individuals in a population N, the number of groups divided from the population S, the number of iterations L and the maximum number of iterations Lₘₐₓ, where 1≤L≤Lₘₐₓ; and initializing L=1;

step 2: generating an initial population P={P₁^{(L)}, . . . , Pᵢ^{(L)}, . . . , P_{N}^{(L)}} according to the inputs and obtaining an initial position Pᵢ^{(L)}={Pₙ^{(L)}, P₁₂^{(L)}, . . . , P_{id}^{(L)}, . . . , Pᵢ₍ₙ₊ₘ₋₁₎^{(L)}} of the i^{th} individual in the L^{th} generation based on the initial population, where Pᵢ^{(L)} is an array of integers between 1 and n+m−1, P_{id}^{(L)} represents a position of the i^{th} individual in tire L^{th} generation in a search space with the d^{th} dimension for indicating a corresponding job, where 1≤d≤n+m−1 and 1≤i≤N; wherein n represents the number of jobs, and m represents the number of machines;

step 3: calculating fitness values F(L)={F₁^{(L)}, . . . , Fᵢ^{(L)}, . . . , F_{N}^{(L)}} for N individuals in the L^{th} generation, where 1≤i≤N and Fᵢ^{(L)} represents a fitness value for the i^{th} individual in the L^{th} generation;

step 4: dividing N individuals in the L^{th} generation into S groups, with a set of S groups denoted by MEX(L)={MEX₁^{(L)}, MEX₂^{(L)}, . . . MEXₖ^{(L)}, . . . MEXₛ^{(L)}}, where MEXₖ^{(L)}={Sₖ₁^{(L)}, . . . , Sₖₕ^{(L)}, . . . , S_{k(N/S)}^{(L)}} represents the k^{th} group in all groups in the L^{th} generation, where 1≤k≤S and 1≤h≤N/S; and setting k=1, wherein sₖₕ^{(L)} represents the h^{th} individual in the k^{th} group;

step 5: performing a local search operator on the h^{th} individual sₖₕ^{(L)} in the group MEXₖ^{(L)} and updating the group MEXₖ^{(L)};

step 6: repeating the step 5 until the local search operator is performed on all individuals in the group MEXₖ^{(L)};

step 7: randomly selecting two individuals from the group MEXₖ^{(L)} to perform a global search operator and updating the group MEXₖ^{(L)};

step 8: assigning k+1 to k and determining whether k≤S is satisfied currently; if so, performing the step 6; or otherwise, performing the step 9;

step 9: gathering groups updated in the step 7 to obtain an updated population P;

step 10: randomly selecting two individuals from P to perform a greedy path relinking operator and updating P; and

step 11: assigning L+1 to L and determining whether L≤Lₘₐₓ is satisfied currently; if so, performing the step 3; or otherwise, representing the completion of Lₘₐₓ iterations; and

an output module for outputting the iteration result as a scheme of assigning jobs to each machine and a scheduling result of processing sequences on each machine.

Various embodiments of the present disclosure may be combined with one or more of these features and other features described herein. The properties and advantages of the present disclosure may be better understood with reference to the detailed description below.

### BRIEF DESCRIPTION OF THE DRAWINGS

Various other advantages and benefits will become apparent to a person of ordinary skill in the art by reading the following detailed description of the preferred embodiments. The drawings are only for the purpose of illustrating the preferred embodiments, but not for the purpose of limiting the present disclosure. Also, identical components are denoted by identical reference numbers throughout the drawings in which:

FIG. 1 is a flowchart of a method for collaborative scheduling of production and transportation based on shuffled frog leaping and path relinking algorithms according to embodiments of the present disclosure;

FIG. 2 is a schematic diagram of a production and transportation process by the method for collaborative scheduling of production and transportation based on shuffled frog leaping and path relinking algorithms according to embodiments of the present disclosure; and

FIG. 3 is a schematic diagram of a system for collaborative scheduling of production and transportation based on shuffled frog leaping and path relinking algorithms according to embodiments of the present disclosure.

### DETAILED DESCRIPTION OF THE PRESENT INVENTION

The technical solutions in the embodiments of the present disclosure will be clearly and completely described below with reference to the accompanying drawings. Apparently, the embodiments described herein are merely a part but not all of the embodiments of the present disclosure. All other embodiments obtained by a person of ordinary skill in the art without paying any creative effort on the basis of the embodiments in the present disclosure shall fall into the protection scope of the present disclosure.

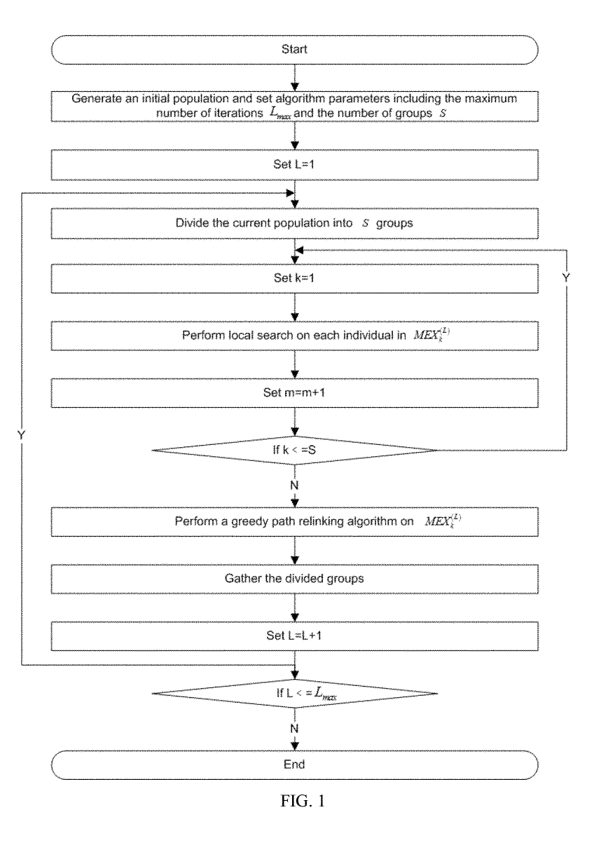

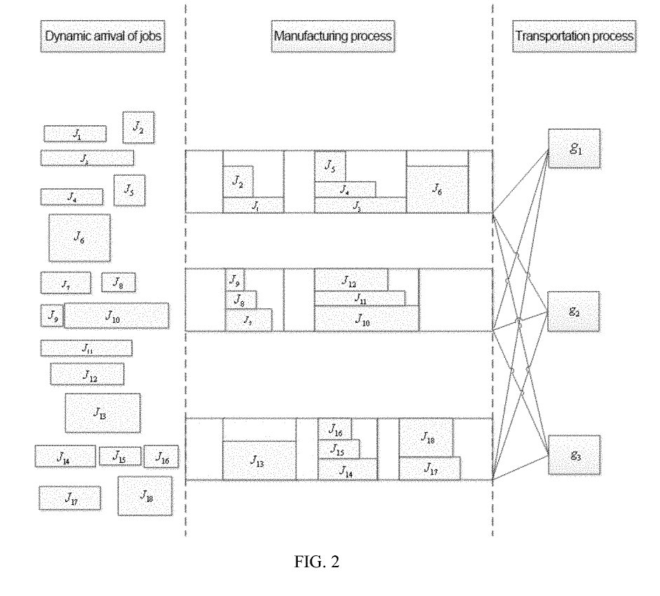

As shown in FIGS. 1 and 2, a model is established for the collaborative scheduling of production and transportation where the size of jobs, the production time, the arrival time of jobs and the transportation time on different transportation routes are different, and then a solution is obtained by shuffled frog leaping and path relinking algorithms, thus obtaining a set of optimization schemes of scheduling transportation and production, so that the overall operating cost is greatly reduced for target enterprises and the operating efficiency of enterprises is improved. Specifically, in a method for collaborative scheduling of production and transportation based on shuffled frog leaping and path relinking algorithms, n jobs ordered by G clients disturbed at different positions are appropriately scheduled to m machines for processing. After the completion of processing at the machines, all processed jobs are immediately transported to clients ordering the jobs. A set of jobs consisting of n jobs is denoted by J={J₁, . . . , Jⱼ, . . . Jₙ}, where Jⱼ represents the j^{th} job and 1≤j≤n, and the size of the j^{th} job Jⱼ is denoted by xⱼ; a set of machines consisting of m machines is denoted by M={M₁, . . . , Mᵤ, . . . Mₘ}, where Mᵤ represents the u^{th} machine and 1≤u≤m; the time for the job Jⱼ to the machine Mᵤ is denoted by rⱼᵤ, and the processing time for the job Jⱼ at the machine Mᵤ is denoted by Pⱼᵤ; a set of G clients is denoted by GU={gu₁, . . . , gu_{g}, . . . gu_{G}}, where 1≤g≤G; and a set of time for transporting jobs from machines to clients is denoted by

$$T = \vert \begin{matrix}{T}_{11} & {T}_{12} & ⋯ & {T}_{1 g} \\ {T}_{21} & {T}_{22} & ⋯ & {T}_{2 g} \\ ⋮ & ⋮ & ⋮ & ⋮ \\ {T}_{m 1} & {T}_{m 2} & ⋯ & {T}_{mg}\end{matrix} \vert ,$$

where T_{ug} represents the time for transporting jobs from the machine Mᵤ to the client gu_{g}, 1≤u≤m and 1≤g≤G.

The method for collaborative scheduling of production and transportation comprises:

step 1: initializing parameters in shuffled frog leaping and path relinking algorithms, including the total number of individuals in a population N, the number of groups divided from the population S, the number of iterations L and the maximum number of iterations Lₘₐₓ, where 1≤L≤Lₘₐₓ; and initializing L=1;

step 2: generating an initial population P={P₁^{(L)}, . . . , Pᵢ^{(L)}, . . . , P_{N}^{(L)}} and obtaining an initial position Pᵢ^{(L)}={Pₙ^{(L)}, P₁₂^{(L)} . . . , P_{id}^{(L)}, . . . , Pᵢ₍ₙ₊ₘ₋₁₎^{(L)}} of the i^{th} individual in the L^{th} generation, where Pᵢ^{(L)} is an array of integers between 1 and n+m−1, P_{id}^{(L)} represents a position of i^{th} individual in the L^{th} generation in a search space with the d^{th} dimension, where 1≤d≤n+m−1 and 1≤i≤N; wherein n represents the number of jobs, and m represents the number of machines

step 3: calculating fitness values F(L)={F₁^{(L)}, . . . , Fᵢ^{(L)}, . . . , F_{N}^{(L)}} for N individuals in the L^{th} generation, where 1≤i≤N, and Fᵢ^{(L)} L represents a fitness value for the i^{th} individual in the L^{th} generation;

step 4: dividing N individuals in the L^{th} generation into S groups, with a set of S groups denoted by MEX(L)={MEX₁^{(L)}, MEX₂^{(L)}, . . . MEXₖ^{(L)}, . . . MEXₛ^{(L)}}, where MEXₖ^{(L)}={Sₖ₁^{(L)}, . . . , Sₖₕ^{(L)}, . . . , S_{k(N/S)}^{(L)}} represents the k^{th} group in all groups in the L^{th} generation, where 1≤k≤S and 1≤h≤N/S; and setting k=1, wherein sₖₕ^{(L)} represents the h^{th} individual in the k^{th} group;

step 5: performing a local search operator on the h^{th} individual sₖₕ^{(L)} in the group MEXₖ^{(L)} and updating the group MEXₖ^{(L)};

step 6: repeating the step 5 until the local search operator is performed on all individuals in the group MEXₖ^{(L)};

step 7: randomly selecting two individuals from the group MEXₖ^{(L)} to perform a global search operator and updating the group MEXₖ^{(L)};

step 8: assigning k+1 to k and determining whether k≤S is satisfied currently; if so, performing the step 6; or otherwise, performing the step 9;

step 9: gathering groups updated in the step 7 to obtain an updated population P;

step 10: randomly selecting two individuals from P to perform a greedy path relinking operator and updating P; and

step 11: assigning L+1 to L and determining whether L≤Lₘₐₓ is satisfied; if so, performing the step 3; or otherwise, representing the completion of Lₘₐₓ iterations; and outputting the iteration result as a scheme of assigning jobs to each machine and a scheduling result of processing sequences on each machine.

Wherein, in the step 3, calculating a fitness value Fᵢ^{(L)} for the i^{th} individual Pᵢ^{(L)}={Pₙ^{(L)}, P₁₂^{(L)}, . . . , P_{id}^{(L)}, . . . , Pᵢ₍ₙ₊ₘ₋₁₎^{(L)}} in the L^{th} generation may include:

step 3.1: setting u=1,d=1,Cₘₐₓ=0, where Cₘₐₓ is the maximum makespan time, and d represents the d^{th} position of solution vectors;

step 3.2: determining whether P_{id}^{(L)} is not greater than n; if so, assigning a job J_{P}_{_{id}}_{^{(L)}} to a machine mᵤ; or otherwise, performing the step 3.4, where mᵤ represents the u^{th} machine;

step 3.3: determining whether d≤n+m−1 is satisfied; if so, assigning d+1 to d and performing the step 3.2; or otherwise, outputting the fitness value

$${F}_{i}^{( L )} = \frac{1}{{C}_{max}}$$

for the i^{th} individual in the L^{th} generation and ending the process of calculating the fitness value;

step 3.4: placing the first unassigned job in a list of jobs assigned to the machine mᵤ in a batch capable of containing the first unassigned job; if the remaining space of all batches cannot contain the first unassigned job currently, generating a new batch with a capacity of C and placing the first unassigned job in the new batch, wherein the remaining space is a difference between the capacity C and the sum of the size of all jobs placed in the corresponding batch; and repeating the process until all jobs in a set of jobs are assigned to corresponding batches;

step 3.5: sequencing the obtained batches in a non-descending order of the arrival time for batches and sequencing batches with the same arrival time in a non-descending order of the processing time for jobs; processing according to the arrangement order of batches, denoting the maximum time required for transporting a job in all jobs on the machine mᵤ to a specific client by Tᵤ and denoting the maximum completion time for all jobs on the machine mᵤ by Cᵤ; determining whether Cᵤ+Tᵤ is greater than Cₘₐₓ, if so assigning Cᵤ+Tᵤ to Cₘₐₓ, where the arrival time for a batch is the maximum arrival time for jobs in the batch and the processing time for the batch is the maximum processing time for jobs in the batch; and

step 3.6: assigning u+1 to u and performing the step 3.2.

Optionally, in the step 4, grouping the population P may include:

step 4.1: sequencing N individuals in the population P={P₁, P₂, . . . , P_{N}} in a non-ascending order of fitness values and assuming Temp=N, where Temp is the total number of ungrouped individuals currently;

step 4.2: assuming l=1;

step 4.3: calculating the percentage Prob={Prob₁, . . . , Probₓ, . . . Prob_{Temp}} of a fitness value for each ungrouped individual to the sum of fitness values for ungrouped individuals in turn, where Probₓ represents the percentage of a fitness value for the x^{th} ungrouped individual to the sum of fitness values for ungrouped individuals and 1≤x≤Temp;

step 4.4: assuming t=1 and

$${\sum }_{x = 1}^{0} {Prob}_{x} = 0 ,$$

and generating a random number Rand within [0,1];

step 4.5: determining whether

$${\sum }_{x = 1}^{t - 1} {Prob}_{x} \leq Rand < {\sum }_{x = 1}^{t} {Prob}_{x}$$

is satisfied; if so, assigning an individual Sₜ to the group MEXₖ^{(L)}; or otherwise, assuming t=t+1 and repeating the step 4.5; and

step 4.6: determining whether Temp is equal to 1; if so, ending the grouping; or otherwise, assigning Temp−1 to Temp and determining whether l is equal to S; if so, performing the step 4.2; or otherwise assigning l+1 to l and performing the step 4.3.

Optionally, in the step 5, performing local search on MEXₖ^{(L)} may include:

step 5.1: initializing parameters for local search, including the number of iterations it and the maximum number of iterations imax, where 1≤it≤imax; and initializing it=1;

step 5.2: assuming h=1;

step 5.3: randomly selecting any two positions for the h^{th} individual sₖₕ^{(L)} in the group MEXₖ^{(L)} for exchange to obtain a new individual denoted by s′ₕ, and calculating a fitness value for the individual s′ₕ;

step 5.4: randomly selecting any one element of the individual sₖₕ^{(L)}, randomly inserting the element into another position to obtain a new individual denoted by s′ₕ, and calculating a fitness value for the individual s′ₕ;

step 5.5: determining whether the fitness value for sₕ is greater than the fitness value for s′ₕ, if so, assigning s′ₕ to s′ₕ;

step 5.6: determining whether the fitness value for s′ₕ is greater than the fitness value for the individual sₖₕ^{(L)}, if so, assigning s′ₕ to the individual sₖₕ^{(L)};

step 5.7: determining whether h is not greater than N/S; if so, returning to the step 5.3; and

step 5.8: determining whether it is not greater than imax; if so, assigning it+1 to it and retaining to the step 5.2; or otherwise, ending the local search.

Optionally the step 6 may include:

step 6.1: randomly selecting two individuals sₐ^{(L)}={sₐ₁^{(L)}, sₐ₂^{(L)}, . . . , s_{ad}^{(L)}, . . . , sₐ₍ₙ₊ₘ₋₁₎^{(L)}} and s_{b}^{(L)}={s_{b1}^{(L)}, s_{b2}^{(L)}, . . . , s_{bd}^{(L)}, . . . , s_{b(n+m-1)}^{(L)}} from the k^{th} group MEXₖ^{(L)} in the L^{th} generation;

step 6.2: generating a random number Rand within [0,1];

step 6.3: if Rand >0.5, assigning the d^{th} position s_{ad}^{(L)} of the individual sₐ^{(L)} to the d^{th} position of a new individual s_{new}; or otherwise, assigning the d^{th} position s_{bd}^{(L)} of the individual sₐ^{(L)} to the d^{th} position of the new individual s_{new};

step 6.4: repeating the steps 6.2 and 6.3 until all positions are iterated; and

step 6.5: calculating a fitness value for the new individual s_{new} , determining whether the fitness value for the individual s_{new} is greater than the greatest fitness value for an individual in MEXₖ^{(L)}; if so, assigning the individual s_{new} to the individual with the greatest fitness value in MEXₖ^{(L)}.

Optionally, the step 10 may include:

step 10.1: randomly dividing the whole population P into two groups and assuming r=1;

step 10.2: denoting an individual with the greatest fitness value in the first group by s_{c}^{(L)} and denoting an individual with the greatest fitness value in the second group by s_{d}^{(L)}; using s_{c}^{(L)} as an initial solution of the path relinking algorithm and using s_{d}^{(L)} as an oriented solution of the path relinking algorithm; and assigning s_{c}^{(L)} to s(r), where s(r) and s_{c}^{(L)} have a same constitution;

step 10.3: assuming D={v|s_{cd}^{(L)}≠s_{dd}¹, d=1,2, . . . , n}, where v represents that values for s_{c}^{(L)} and s_{d}^{(L)} in the v^{th} dimension are different and D represents a set of v;

step 10.4: determining whether D is a null set; if so, performing the step 10.8;

step 10.5: for all v∈D, replacing a value for the v^{th} position of s(r) with a value for the v^{th} position of s_{d}^{(L)} to generate a new individual and place the new individual in a set CS(r), where CS(r) is a set of new solutions generated by the r^{th} path relinking;

step 10.6: calculating fitness values for all individuals in the set CS(r), selecting an individual with the greatest fitness value to assign to s(r), and deleting v corresponding to the individual with the greatest fitness value from the set D;

step 10.7: assigning r+1 to r, placing individuals in the set CS(r) into the set CS, and performing the step 10.4, where CS is a set of all new solutions generated by the current algorithm; and

step 10.8: determining whether an individual with the greatest fitness value in the set CS is better than the initial solution s_{c}^{(L)}; if so, assigning the individual with the greatest fitness value in the set CS to the initial solution s_{c}^{(L)}; or otherwise, randomly selecting an individual from the set CS to assign to s_{c}^{(L)}.

Compared with the prior art, the embodiments of the present disclosure have the following advantages.

In the embodiments of the present disclosure, shuffled frog leaping and path relinking algorithms are proposed in view of the collaborative scheduling of production and transportation considering parallel-batching and dynamic arrival of different jobs. By introducing a global search strategy for the disadvantage of poor local search capacity in the traditional frog leaping algorithm, and improving the quality of elegant solutions in a population by the greedy path relinking algorithm on this basis, the joint optimization of transportation and production of jobs in batches in the production process of manufacturing enterprises is achieved, the overall economic benefit of enterprises is optimized, the energy consumption is reduced, the cost is saved, and the service level of enterprises is enhanced.

By the grouping strategy in the traditional shuffled frog leaping algorithm, better individuals will be gathered in a certain group. This will result in poor grouping effect and it will be difficult to ensure the diversity of populations in groups. By the grouping strategy based on random sampling in the present disclosure, by introducing certain random interference in the grouping process, the randomness of individual distribution is enhanced to some extent, and the diversity of populations in each group is enhanced while ensuring uniform distribution of elegant solutions.

Similar to particle swarm optimization, the local search strategy of the traditional shuffled frog leaping algorithm has main disadvantages of premature convergence and poor local optimization capacity. In the present disclosure, by adding a global search process on the basis of local search of individuals in each group at each iteration, the search range of the algorithm is widened, it is advantageous for the local optimization of the algorithm, and the premature convergence of the algorithm is avoided.

In the embodiments of the present disclosure, the greedy path relinking algorithm is introduced to improve the quality of elegant solutions in the population after the completion of each iteration. Two elegant solutions in the population are respectively used as an oriented solution and an initial solution, and new solutions with higher quality are generated by the path relinking algorithm to replace the existing elegant solutions, so that the search depth of the algorithm is greatly enhanced and the best solution is obtained gradually by the algorithm.

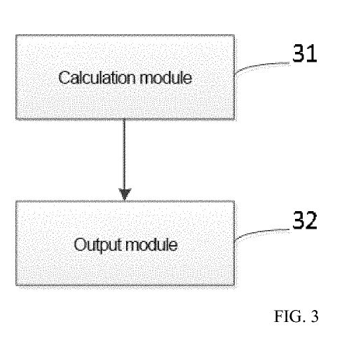

Based on the same concept, the present disclosure further provides a system for collaborative scheduling of production and transportation based on shuffled frog leaping and path relinking algorithms, with reference to FIG. 3, including:

a calculation module 31 for performing:

step 1: by using the processing time for jobs and the time for transportation between each machine and clients as inputs, initializing parameters in shuffled frog leaping and path relinking algorithms, including the total number of individuals in a population N, the number of groups divided from the population S, the number of iterations L and the maximum number of iterations Lₘₐₓ, where 1≤L≤Lₘₐₓ; and initializing L=1;

step 2: generating an initial population P={P₁^{(L)}, . . . , Pᵢ^{(L)}, . . . , P_{N}^{(L)}} and obtaining an initial position Pᵢ^{(L)}={Pₙ^{(L)}, P₁₂^{(L)}, . . . , P_{id}^{(L)}, . . . , Pᵢ₍ₙ₊ₘ₋₁₎^{(L)}} of the i^{th} individual in the generation, where P₁^{(L)} is an array of integers between 1 and n+m−1, P_{id}^{(L)} represents a position of the i^{th} individual in the L^{th} generation in a search space with the d^{th} dimension for indicating a corresponding job, where 1≤d≤n+m−1 and 1≤i≤N; wherein n represents the number of jobs, and m represents the number of machines;

step 3: calculating fitness values F(L)={F₁^{(L)}, . . . , Fᵢ^{(L)}, . . . , F_{N}^{(L)}} for N individuals in the L^{th} generation, where 1≤i≤N and Fᵢ^{(L)} represents a fitness value for the i^{th} individual in the L^{th} generation;

step 4: dividing N individuals in the L^{th} generation into S groups, with a set of S groups denoted by MEX(L)={MEX₁^{(L)}, MEX₂^{(L)}, . . . MEXₖ^{(L)}, . . . MEXₛ^{(L)}}, where MEXₖ^{(L)}={Sₖ₁^{(L)}, Sₖₕ^{(L)}, . . . , S_{k(N/S)}^{(L)}} represents the k^{th} group in all groups in the L^{th} generation, where 1≤k≤S and 1≤h≤N/S; and setting k=1, wherein sₖₕ^{(L)} represents the h^{th} individual in the k^{th} group;

step 5: performing a local search operator on the h^{th} individual sₖₕ^{(L)} in the group MEXₖ^{(L)} and updating the group MEXₖ^{(L)};

step 6: repeating the step 5 until the local search operator is performed on all individuals in the group MEXₖ^{(L)};

step 7: randomly selecting two individuals from the group MEXₖ^{(L)} to perform a global search operator and updating the group MEXₖ^{(L)};

step 8: assigning k+1 to k and determining whether k≤S is satisfied; if so, performing the step 6; or otherwise, performing the step 9;

step 9: gathering groups updated in the step 7 to obtain an updated population P;

step 10: randomly selecting two individuals from P to perform a greedy path relinking operator and updating P; and

step 11: assigning L+1 to L and determining whether L≤Lₘₐₓ is satisfied; if so, performing the step 3: or otherwise, representing the completion of Lₘₐₓ iterations; and

an output module 32 for outputting the iteration result as a scheme of assigning jobs to each machine and a scheduling result of processing sequences on each machine.

The system as described in the present embodiment may implement the method for collaborative scheduling of production and transportation based on shuffled frog leaping and path relinking algorithms according to the embodiments of the present disclosure. Therefore, based on the method for collaborative scheduling of production and transportation based on shuffled frog leaping and path relinking algorithms, the specific implementations of the system and various variations thereof will be clear for those skilled in the art, and how the system can implement the method will not be described herein in detail. Systems used by those skilled in the art to implement the method for collaborative scheduling of production and transportation based on shuffled frog leaping and path relinking algorithms in the embodiments of the present disclosure fall into the protection scope of the application.

An embodiment of the present disclosure further discloses a computer program product which includes computer programs. The computer programs include program instructions that, when executed by a computer, enable the computer to execute the method according to the above method embodiments, for example, the method described in the first aspect.

A lot of specific details have been described in the specification provided herein. However, it can be appreciated that the embodiments of the present disclosure may be practiced without these specific details. In some examples, well-known methods, structures and techniques have not been shown in detail so as not to obscure the understanding to this specification.

Similarly, it should be appreciated that in the above description of exemplary embodiments of the present disclosure, various features of the present disclosure are sometimes combined together in a single embodiment, figure, or description thereof for the purpose of streamlining the disclosure and aiding in the understanding of one or more of the various inventive aspects. However, the method of the disclosure is not to be interpreted as reflecting an intention that the claimed embodiments of the present disclosure require more features than those expressly recited in each claim. Rather, as reflected by the following claims, inventive aspects are less than all features of a single foregoing embodiment. Thus, the claims following the specific implementation mode are hereby expressly incorporated herein just as each claim itself is a separate embodiment of the present disclosure.

What is claimed is:

1. A method for collaborative scheduling of production and transportation based on shuffled frog leaping and path relinking algorithms, comprising:
step 1: by using the processing time for jobs and the time for transportation between each machine and clients as inputs, initializing parameters in shuffled frog leaping and path relinking algorithms, including the total number of individuals in a population N, the number of groups divided from the population S, the number of iterations L and the maximum number of iterations Lₘₐₓ, where 1≤L≤Lₘₐₓ; and initializing L=1;
step 2: generating an initial population P={P₁^{(L)}, . . . , Pᵢ^{(L)}, . . . , P_{N}^{(L)}} according to the inputs and obtaining an initial position Pᵢ^{(L)}={Pₙ^{(L)}, P₁₂^{(L)}, . . . , P_{id}^{(L)}, . . . , Pᵢ₍ₙ₊ₘ₋₁₎^{(L)}} of the i^{th} individual in the L^{th} generation based on the initial population, where Pᵢ^{(L)} is an array of integers between 1 and n+m−1, P_{id}^{(L)} represents a position of the i^{th} individual in the L^{th} generation in a search space with the d^{th} dimension for indicating a corresponding job, where 1≤d≤n+m−1, 1≤i≤N, wherein n represents the number of jobs, and m represents the number of machines;
step 3: calculating fitness values F(L)={F₁^{(L)}, . . . , Fᵢ^{(L)}, . . . , F_{N}^{(L)}} for N individuals in the L^{th} generation, where 1≤i≤N and Fᵢ^{(L)} represents a fitness value for the i^{th} individual in the L^{th} generation;
step 4: dividing N individuals in the L^{th} generation into S groups, with a set of S groups denoted by MEX(L)={MEX₁^{(L)}, MEX₂^{(L)}, . . . MEXₖ^{(L)}, . . . MEXₛ^{(L)}}, where MEXₖ^{(L)}={sₖ₁^{(L)}, . . . , sₖₕ^{(L)}, . . . , S_{k(N/S)}^{(L)}} represents the k^{th} group in all groups in the L^{th} generation, where 1≤k≤S and 1≤h≤N/S; and setting
k=1, wherein sₖₕ^{(L)} represents the h^{th} individual in the k^{th} group
step 5: performing a local search operator on the h^{th} individual sₖₕ^{(L)} in the group MEXₖ^{(L)} and updating the group MEXₖ^{(L)};
step 6: repeating the step 5 until the local search operator is performed on all individuals in the group MEXₖ^{(L)};
step 7: randomly selecting two individuals from the group MEXₖ^{(L)} to perform a global search operator and updating the group MEXₖ^{(L)};
step 8: assigning k+1 to k and determining whether k≤S is satisfied currently; if so, performing the step 6; or otherwise, performing the step 9;
step 9: gathering groups updated in the step 7 to obtain an updated population P;
step 10: randomly selecting two individuals from P to perform a greedy path relinking operator and updating P; and
step 11: assigning L+1 to L and determining whether L≤Lₘₐₓ is satisfied currently; if so, performing the step 3; or otherwise, representing the completion of Lₘₐₓ iterations; and outputting the iteration result as a scheme of assigning jobs to each machine and a scheduling result of processing sequences on each machine.

2. The method according to claim 1, wherein, in the step 3, calculating a fitness value Fᵢ^{(L)} for the i^{th} individual Pᵢ^{(L)}={Pₙ^{(L)}, P₁₂^{(L)}, . . . , P_{id}^{(L)}, . . . , Pᵢ₍ₙ₊ₘ₋₁₎^{(L)}} in the L^{th} generation comprises:
step 3.1: setting u=1, d=1, Cₘₐₓ₌0, where Cₘₐₓ is the maximum makespan time, and d represents the d^{th} position of solution vectors;
step 3.2: determining whether P_{id}^{(L)} is not greater than n; if so, assigning a job J_{P}_{_{id}}_{^{(L)}} to a machine mᵤ; or otherwise, performing the step 3.4, where mᵤ represents the uth machine;
step 3.3: determining whether d≤n+m−1 is satisfied; if so, assigning d+1 to d and performing the step 3.2; or otherwise, outputting the fitness value
$${F}_{i}^{( L )} = \frac{1}{{C}_{max}}$$
for the i^{th} individual in the L^{th} generation and ending the process of calculating the fitness value;
step 3.4: placing the first unassigned job in a list of jobs assigned to the machine mᵤ in a batch capable of containing the first unassigned job; if the remaining space of all batches cannot contain the first unassigned job currently, generating a new batch with a capacity of C and placing the first unassigned job in the new batch, wherein the remaining space is a difference between the capacity C and the sum of the size of all jobs placed in the corresponding batch; and repeating this step until all jobs in a set of jobs are assigned to corresponding batches;
step 3.5: sequencing batches obtained in the step 3.4 in a non-descending order of the arrival time for batches and sequencing batches with the same arrival time in a non-descending order of the processing time for jobs; processing according to the arrangement order of batches, denoting the maximum time required for transporting a job in all jobs on the machine mᵤ to a specific client by Tᵤ and denoting the maximum completion time for all jobs on the machine Mᵤ by Cᵤ; determining whether Cᵤ+Tᵤ is greater than Cₘₐₓ, if so, assigning Cᵤ+Tᵤ to Cₘₐₓ, where the arrival time for a batch is the maximum arrival time for jobs in the batch and the processing time for the batch is the maximum processing time for jobs in the batch; and
step 3.6: assigning u+1 to u and performing the step 3.2.

3. The method according to claim 1, wherein, in the step 4, grouping the population P comprises:
step 4.1: sequencing individuals in the population P={P₁, P₂, . . . , P_{N}} in a non-ascending order of fitness values and assuming Temp=N, where Temp is the total number of ungrouped individuals currently;
step 4.2: assuming l=1;
step 4.3: calculating the percentage Prob={Prob₁, . . . , Probₓ, . . . , Prob_{Temp}} of a fitness value for each ungrouped individual to the sum of fitness values for ungrouped individuals in turn, where Probₓ represents the percentage of a fitness value for the x^{th} ungrouped individual to the sum of fitness values for ungrouped individuals and 1≤x≤Temp.
step 4.4: assuming t=1 and
$${\sum }_{x = 1}^{0} {Prob}_{x} = 0 ,$$
and generating a random number Rand within [0,1];
step 4.5: determining whether
$${\sum }_{x = 1}^{t} {Prob}_{x} \leq Rand < {\sum }_{x = 1}^{t} {Prob}_{x}$$
is satisfied; if so, assigning an individual sₜ to the group MEXₖ^{(L)}; or otherwise, assuming t=t+1 and repeating the step 4.5; and
step 4.6: determining whether Temp is equal to 1; if so, ending the grouping; or otherwise, assigning Temp−1 to Temp and determining whether l is equal to S; if so, performing the step 4.2; or otherwise, assigning l+1 to l and performing the step 4.3.

4. The method according to claim 1, wherein, in the step 5, performing local search on MEXₖ^{(L)} comprises:
step 5.1: initializing parameters for local search, including the number of iterations it and the maximum number of iterations imax, where 1≤it≤imax; and initializing it=1;
step 5.2: assuming h=1;
step 5.3: randomly selecting any two positions for the h^{th} individual sₖₕ^{(L)} in the group MEXₖ^{(L)} for exchange to obtain a new individual denoted by s′ₕ, and calculating a fitness value for the individual s′ₕ;
step 5.4: randomly selecting any one element of the individual sₖₕ^{(L)}, randomly inserting the element into another position to obtain a new individual denoted by s′ₕ, and calculating a fitness value for the individual s′ₕ;
step 5.5: determining whether the fitness value for s′ₕ is greater than the fitness value for s′ₕ, if so, assigning s′ₕ to s′ₖ;
step 5.6: determining whether the fitness value for s′ₕ is greater than the fitness value for the individual sₖₕ^{(L)}, if so, assigning s′ₕ to the individual sₖₕ^{(L)};
step 5.7: determining whether h is not greater than N/S; if so, returning to the step 5.3; and
step 5.8: determining whether it is not greater than imax; if so, assigning it+1 to it and returning to the step 5.2; or otherwise, ending the local search.

5. The method according to claim 1, wherein, the step 6 comprises:
step 6.1: randomly selecting two individuals sₐ^{(L)}={sₐ₁^{(L)}, sₐ₂^{(L)}, . . . , s_{ad}^{(L)}, . . . , sₐ₍ₙ₊ₘ₋₁₎^{(L)}} and s_{b}^{(L)}={s_{b1}^{(L)}, s_{b2}^{(L)}, . . . , s_{bd}^{(L)}, . . . , s_{b(n+m-1)}^{(L)}} from the k^{th} group MEXₖ^{(L)} in the L^{th} generation;
step 6.2: generating a random Rand within [0,1];
step 6.3: if Rand >0.5, assigning the d^{th} position s_{bd}^{(L)} of the individual sₐ^{(L)} to the d^{th} position of a new individual s_{new}; or otherwise, assigning the d^{th} position s_{bd}^{(L)} of the individual sₐ^{(L)} to the d^{th} position of the new individual s_{new};
step 6.4: repeating the steps 6.2 and 6.3 until all positions are iterated; and
step 6.5: calculating a fitness value for the new individual s_{new}, determining whether the fitness value for the individual s_{new} is greater than the greatest fitness value for an individual in MEXₖ^{(L)}; if so, assigning the individual s_{new} to the individual with the greatest fitness value in MEXₖ^{(L)}.

6. The method according to claim 1, wherein, the step 10 comprises:
step 10.1: randomly dividing the whole population P into two groups and assuming r=1;
step 10.2: denoting an individual with the greatest fitness value in the first group by s_{c}^{(L)} and denoting an individual with the greatest fitness value in the second group by s_{d}^{(L)}; using s_{c}^{(L)} as an initial solution of the path relinking algorithm and using s_{d}^{(L)} as an oriented solution of the path relinking algorithm; and assigning s_{c}^{(L)} to s(r), where s(r) and s_{c}^{(L)} have a same constitution;
step 10.3: assuming D={v|s_{cd}^{(L)}≠s_{dd}¹, d=1,2, . . . , n}, where v represents that values for s_{c}^{(L)} and s_{d}^{(L)} in the v^{th} dimension are different and D represents a set of v;
step 10.4: determining whether D is a null set; if so, performing the step 10.8;
step 10.5: for all v∈D, replacing a value for the v^{th} position of s(r) with a value for the v^{th} position of s_{d}^{(L)} to generate a new individual and place the new individual in a set CS(r), where CS(r) is a set of new solutions generated by the r^{th} path relinking;
step 10.6: calculating fitness values for all individuals in the set CS(r), selecting an individual with the greatest fitness value to assign to s(r), and deleting v corresponding to the individual with the greatest fitness value from the set D;
step 10.7: assigning r+1 to r, placing individuals is the set CS(r) into the set CS, and performing the step 10.4, where CS is a set of all new solutions generated by the current algorithm; and
step 10.8: determining whether an individual with the greatest fitness value in the set CS is better than the initial solution s_{c}^{(L)}; if so, assigning the individual with the greatest fitness value in the set CS to the initial solution s_{c}^{(L)}; or otherwise, randomly selecting an individual from the set CS to assign to s_{c}^{(L)}.

7. A system for collaborative scheduling of production and transportation based on shuffled frog leaping and path relinking algorithms, comprising:
a calculation module for performing:
step 1: by using the processing time for jobs and the time for transportation between each machine and clients as inputs, initializing parameters in shuffled frog leaping and path relinking algorithms, including the total number of individuals in a population N, the number of groups divided from the population S, the number of iterations L and the maximum number of iterations Lₘₐₓ, where 1≤L≤Lₘₐₓ; and initializing L=1;
step 2: generating an initial population P={P₁^{(L)}, . . . , Pᵢ^{(L)}, . . . , P_{N}^{(L)}} according to the inputs and obtaining an initial position Pᵢ^{(L)}={Pₙ^{(L)}, P₁₂^{(L)}, . . . , P_{id}^{(L)}, . . . , Pᵢ₍ₙ₊ₘ₋₁₎^{(L)}} of the i^{th} individual in the L^{th} generation based on the initial population, where Pᵢ^{(L)} is an array of integers between 1 and n+m−1, P_{id}^{(L)} represents a position of the i^{th} individual in the L^{th} generation in a search space with the d^{th} dimension for indicating a corresponding job, where 1≤d≤n+m−1, 1≤i≤N, wherein n represents the number of jobs, and m represents the number of machines;
step 3: calculating fitness values F(L)={F₁^{(L)}, . . . , Fᵢ^{(L)}, . . . , F_{N}^{(L)}} for N individuals in the L^{th} generation, where 1≤i≤N and Fᵢ^{(L)} represents a fitness value for the i^{th} individual in the L^{th} generation;
step 4: dividing N individuals in the L^{th} generation into S groups, with a set of S groups denoted by MEX(L)={MEX₁^{(L)}, MEX₂^{(L)}, . . . MEXₖ^{(L)}, . . . MEXₛ^{(L)}}, where MEXₖ^{(L)}={sₖ₁^{(L)}, . . . , sₖₕ^{(L)}, . . . , s_{k(N/S)}^{(L)}} represents the k^{th} group in all groups in the L^{th} generation, where 1≤k≤S and 1≤h≤N/S; and setting k=1, wherein sₖₕ^{(L)} represents the h^{th} individual in the k^{th} group;
step 5: performing a local search operator on the h^{th} individual sₖₕ^{(L)} in the group MEXₖ^{(L)} and updating the group MEXₖ^{(L)};
step 6: repeating the step 5 until the local search operator is performed on all individuals in the group MEXₖ^{(L)};
step 7: randomly selecting two individuals from the group MEXₖ^{(L)} to perform a global search operator and updating the group MEXₖ^{(L)};
step 8: assigning k+1 to k and determining whether k≤S is satisfied currently; if so, performing the step 6; or otherwise, performing the step 9;
step 9: gathering groups updated in the step 7 to obtain an updated population P;
step 10: randomly selecting two individuals from P to perform a greedy path relinking operator and updating P; and
step 11: assigning L+1 to L and determining whether L≤Lₘₐₓ is satisfied currently; if so, performing the step 3; or otherwise, representing the completion of Lₘₐₓ iterations; and
an output module for outputting the iteration result as a scheme of assigning jobs to each machine and a scheduling result of processing sequences on each machine.
